(19) United States
(12) Patent Application Publication
(10) Pub. No.: US 2002/0178258 A1
(43) Pub. Date: Nov. 28, 2002

(54) System and method for processing and monitoring telemetry data

(76) Inventors: Sumner K. Hushing III, Littleton, CO (US); John L. Erickson, Littleton, CO (US); Sidney M. Wirtz, Highlands Ranch, CO (US)

Correspondence Address: Marsh Fischmann & Breyfogle LLP, Suite 411, 3151 S. Vaughn Way, Aurora, CO, 80014, US

(21) Appl. No.: 10/152,712

(22) Filed: May 22, 2002

Related U.S. Application Data
(60) Provisional application No. 60/292,711, filed on May 22, 2001.

(51) Int. Cl. G06F 15/173

(52) U.S. Cl. 709/224

(57) ABSTRACT

A method and system provide for the processing and display of telemetry information received from pre-flight and in-flight sensors for launch vehicles. The system is configured to decommutate telemetry information received from the launch pad and launch vehicle such that it may be transmitted over a data network to one or more graphical user interfaces for real-time display. The system is further configured to archive telemetry information received such that it may be retrieved and viewed or combined in various displays with real-time data so as to analyze launch vehicle conditions.

### CROSS REFERENCE TO RELATED APPLICATIONS

This application claims priority from U.S. Provisional Application Serial No. 60/292,711, that was filed on May 22, 2001, that is titled “Automated Data Monitoring System,” and the entire disclosure of which is incorporated by reference in its entirety herein.

### FIELD OF THE INVENTION

The invention described herein relates to the processing and presentation of telemetry data, and more specifically to a system and method for providing real-time and historical access to telemetry data which is presentable in a form which may be manipulated by a system user.

### BACKGROUND OF THE INVENTION

When rocket powered launch vehicles are employed to launch payload, into space or to perform any number of other missions, typically monitoring systems are employed to provide information to a central location as to various operational parameters of the launch vehicle. Typically this information is collected in relation to a known timing signal and accumulated as the vehicle prepares for launch, launches, and then performs its mission.

In particular, launch vehicle pre-flight test and check out may be a labor intensive, time consuming, and costly process. A large portion of this process is consumed with data monitoring and analysis. Traditionally, a large amount of data is collected during pre-flight and launch of a vehicle. Because of the voluminous amount of data, sometimes it is difficult to analyze all information for major test activities and sub system level tests.

Existing systems typically do not include the functionality to provide real-time detection of anomalies in the data which may occur during a test. Anomalies are typically detected when test data for two separate tests are first generated and then compared at a latter time. This offers the distinct disadvantage that during a test, certain parameters may not be adjusted to judge their affect on the detected anomaly.

### SUMMARY OF THE INVENTION

The inventors have recognized that a desirable feature in a telemetry processing system would be the rapid accessibility and accurate assessment of vehicle test data. A desirable system would provide real-time and historical visibility of launch vehicle preflight and post-flight telemetry data to a plurality of users. A key feature would be system interaction of critical events, analysis of out of family conditions across all systems and data trending. The system described herein provides processing for a full bandwidth of data as well as visibility of every measurement sample in the telemetry data stream.

Disclosed herein is a telemetry processing and presentation system configured especially for use in monitoring launch vehicles and ground stations which generate telemetry data. Included in the system is a telemetry processor which is configured to receive telemetry and timing signals from a plurality of different telemetry sources. The telemetry processor is further configured to decommutate data streams included as part of the telemetry signals into individual measurement samples.

Included as part of the system is a first memory which is configured to store telemetry formats which are employable by the telemetry processor for identifying the individual measurement samples and associating the samples with appropriate descriptive information. A second memory is employed to store display formats which are accessible by the telemetry processor for presenting telemetry information in a display format which is presentable on a graphical user interface (GUI). The telemetry processor is connectable to a data network such that the display format information may be transmitted out over the data network to at least one GUI which is connectable to the data network. Each GUI is further configured for selective viewing of different generated displays.

The system described herein may be further configured with a third memory employable to archive measurement samples as they are processed. The telemetry processor is further configured to access the third memory such that various types of archive measurement may be retrieved and transmitted. The telemetry processor may be further configured such that information is provided for displays generated at the GUI's which include both the current measurement samples being processed by the telemetry processor, as well as selected number of archive measurement samples. This simultaneous presentation of new and old data allows for evaluation of current data against previous tests and missions.

In one configuration of the invention the telemetry processor is configured on a networked server which receives time and telemetry over a data network. The telemetry processor may be further configured with a number of processing module which perform such functions as decommutation of serial bit streams, archiving of decommutated data, as well as transmission of real time data to one or more display computer systems connectable to the telemetry processor over a data network.

Each of the display computer systems may be further configured with a data review and analysis tool which provides capability to employ real-time and/or historical data from the archive, and plot the data in a window presentable on a graphical user interface (GUI). Further, the display formats retrievable from memory provide the capability to plot current and/or archived measurement samples in strip chart format. Still further, real time and archived data may be combined in a single plot as a family of curves. The strip chart format may comprise one or more of the measurement samples plotted against a reference values such as time. The telemetry processor is further configured to continually update the strip chart such that the viewing of real-time telemetry information is facilitated. A particular strip chart may be further configured to present both real-time and archived measurement samples.

In order to provide frame of reference, an events database may be included wherein a system user may select a particular event with a reference time period in order to compare real-time vs. archive information. For example, a particular reference time period may be the launch and post launch time periods from a previous launch. A number of strip charts may be presented on each display for simultaneous monitoring.

Another display which is presentable by the system described herein, is a tabular display which present numerical values for one or more measurement samples. The information included, as with a strip charts, may be real-time data which is periodically updated. The tabular display may be configured to display one or more measurement sample types based on user selections. The telemetry processor may be further configured to monitor the measurement samples presented to the tabular display for excursions outside a predetermined range. A system user may provide a range of values to the system for which they wish to receive notification if a selected measurement sample exceeds or falls below. The notice may comprise an audio and/or video warning presentable through the GUI.

Further, the system may be configured such that when selected measurement sample exceeds or falls below an absolute maximum or minimum value respectively, a redline display may be presented on the GUI. This redline display may include a plurality of measurement samples plotted over a predetermined period time so that a system user may discern a trend.

Another feature which may be incorporated in the telemetry processor includes a data filter. The data filter may be employed to filter measurement samples in such a manner that a plot is provided on a display which provides an indication of the trend of the data. This may be useful for the instances when the data is especially dirty.

In yet another configuration of the invention the display system may be configured to present plurality of displays such a strip chart in a single window wherein any of the displays may be further selected for individual viewing. Further, measurements included in one or more strips charts may be shifted along one or more axis for wave shape comparison.

The system described herein may be further configured to include a plurality of telemetry processors interconnected in a redundant fashion. In situations where there are multiple launch sites and/or multiple ground stations, it is advantageous to monitor the plurality of locations, and provide a system user the capability to view data from any location. As such, the multiple telemetry processors may be linked over one or more data networks wherein each telemetry processor is further connectable to each of the networked GUIs.

In operation, during launch, prelaunch, and/or the mission of a vehicle, the various telemetry sources will transmit their signals to the telemetry processing system which includes the telemetry processor. The format of the telemetry signals may comprise pulse code modulation (PCM) data streams. Also received may be various time signals such as the countdown clock signal, as well as any other timing signals being employed by the system. As the telemetry signals are received by the telemetry processor, the serial data streams are decommutated, the telemetry formats are accessed, and the individual measurement samples are identified. According to the invention described herein, the telemetry formats may include such things as: a measurement identification number, measurement description, engineering units, polynomial coefficients for EU conversion, and bit rate, frame and word position information.

Once the measurement samples are identified, they may be included in a selected display format for viewing at a remotely locate a GUI as well as stored in an archive. Once prepared, the displays are transmitted over the data network for viewing.

Particular displays may be generated based on the inputs received from the system users through the GUI. If a particular system user has selected to simultaneously view real-time and archive measurement samples, the selected measurement samples are retrieved from the archive, a common timeframe is identified, and a display created. As described above, the system may include an events database from which a system user may select a particular a event, where the selected event includes an appropriate timeframe. Further commands which may be received from a system user and processed by the telemetry processor which include a zooming function which controls the resolution in which the sample and archive measurements appear on a particular display. According to the system described herein, the resolution may be set such that individual measurement samples are viewable.

If a system users chooses to view a number of different types of displays, as was described above, these display times may include one or more strip charts, as well as one or more tabular display. The telemetry processor will continuously monitor the values of the measurement samples to determine if one or more of the measurements varies outside a preset range. If that does occur, the telemetry processor will provide either a visual or audio alarm to the system user. Further, if the values were to exceed maximum or minimum values, a redline display may be generated and presented showing the most recent trend of the measurement samples.

### BRIEF DESCRIPTIONS OF THE DRAWINGS

FIG. 1 discloses a diagram for the environment within which the system described herein may operate.

FIG. 2 discloses a diagram for the automated data monitoring system (ADMS) architecture.

FIG. 3 discloses a system diagram showing in particular the redundancy characteristics.

FIG. 4 discloses a flow chart which describes the steps performed by the telemetry processor during the processing of telemetry data.

FIG. 5 discloses a plurality of real-time virtual strip charts presented on a display.

FIG. 6 discloses a display which includes a family of curves.

FIG. 7 discloses a flowchart which describes steps performed by system in creating a family of curves plot.

FIGS. 8a and 8b discloses a family of curves plot and also demonstrate the zooming capability of the display system.

FIG. 9 discloses a display which in particular presents the data manipulation capability.

FIG. 10 discloses a tabular display which provides simple current value representations.

FIG. 11 discloses an alarm monitor display configure to monitor selected measurement samples.

FIG. 12 discloses a flow chart which described the steps performed in monitoring selected measurement samples and presenting a redlined display.

FIG. 13 discloses a display which presents the capability for display customization.

### DETAILED DESCRIPTION

Described herein is a system and method for providing real-time rapid evaluation and trending analysis capability for launch vehicles. These launch vehicles may comprise any commercial or military payload rockets, which generates significant amounts of telemetry during pre-launch and flight activities. According to the system and method described herein, significant features include the real-time viewing of selected measurement samples in the telemetry, archive telemetry information, simultaneous presentation of archive and real-time data, as well as various devices for data manipulation and data analysis.

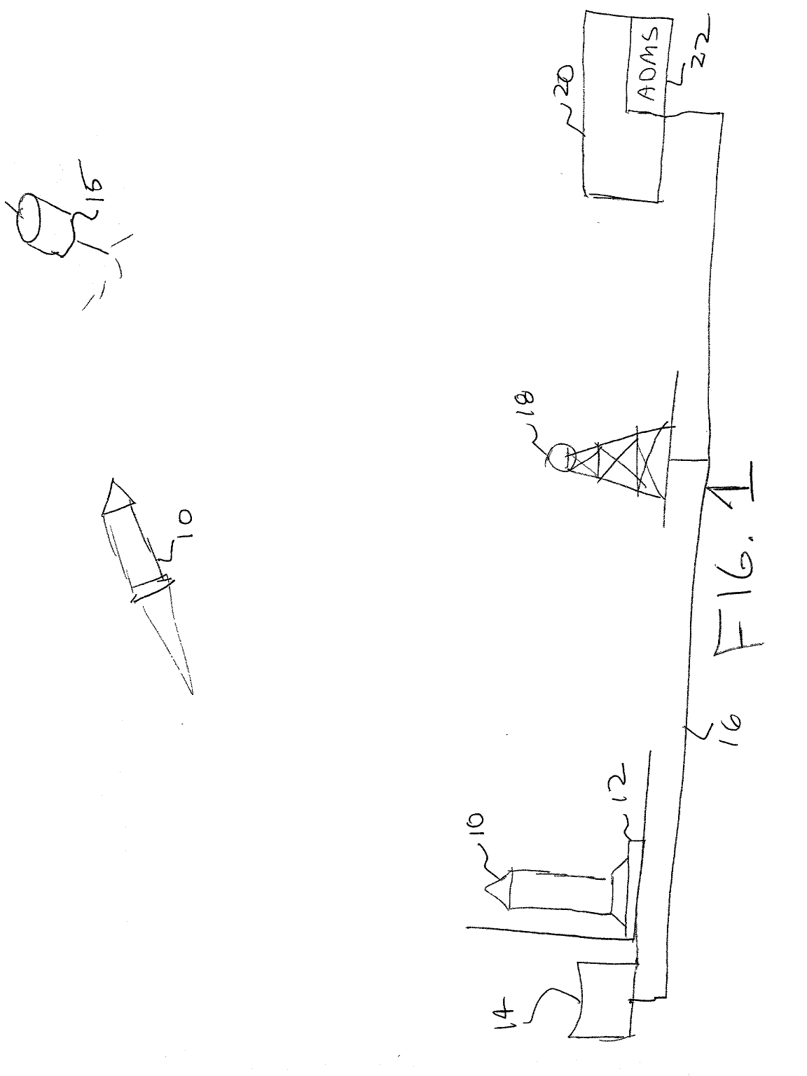

Disclosed in FIG. 1 is a diagram which shows in particular the environment within which the system described herein would operate. Shown is a launch facility which includes launch payload rocket 10 sitting on launch pad 12 prior to launch. In electrical connection with the rocket 10 is data acquisition facility 14 which is configured to received telemetry from the rocket 10 and generate various timing signals such as the range IRIG-B formatted GMT clock signal and the range formatted count down clock signal. These various signals are transmitted out over the communications network 16 to one or more remote locations.

The communications network 16 may comprise one or more separate networks. The communications networks may include a radio network, a local area network (LAN), a wide area network (WAN), and/or the Internet. The communications network 16 is in communication with an operational site 20, which includes the automated data monitoring system (ADMS) 22, which is described in greater detail herein.

Once the rocket 10 has launched, additional systems are included in both the rockets and ground facilities for acquiring and processing data. The rocket 10 may be configured with an antenna apparatus for transmitting telemetry information over the radio waves, to a radio receiver. Apparatus employed for receiving the data signal may include a satellite 15, which in turn transmits the information to radio antenna 18, which is also in connection with communications network 16. Information may also be transmitted from the rocket 10 directly to antenna 18. Once received by antenna 18 from either the rocket or the satellite, the information is transmitted over the communications network 16 to the operational site 20.

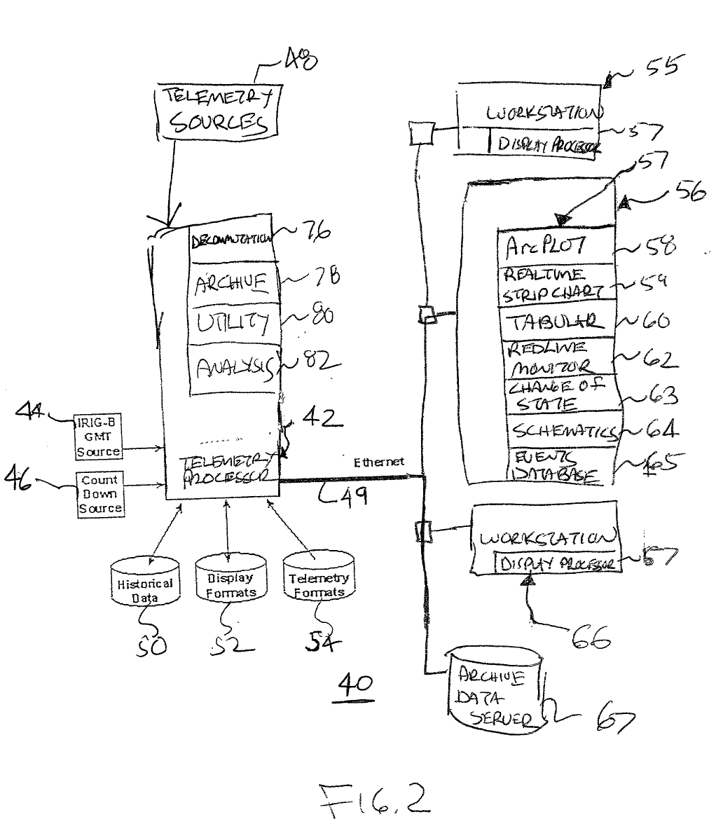

Disclosed in FIG. 2 is a system diagram a single instance of ADMS 22. As was described above, various countdown signals 44 and 46 are generated at the launch site and provided over the data network to the operational site. In addition to the clock signals, other sources of telemetry information provided over the communications network may include pulse code modulated (PCM) data streams transmitted by various telemetry sources 48. Additional PCM or internally generated data streams may be employed as required. The telemetry processor 42 is employable for receiving and processing time and telemetry signals as well as providing access to historical data. The telemetry processor 42 receives data from a number of telemetry sources 48 as well as IRIG-B GMT source 44 and countdown source 46.

The telemetry processor 42 may be configured on any number of commercially available servers, such as the Concurrent Powerhawk, and further include a number of processing modules incorporated therein employable for performing various functions within the system. These processing modules include the decommutation module 76 employable for providing decommutation of the physical and logical data streams into individual measurements. Each measurement is time tagged with the GMT based on a range time signal provided to the processor through IRIG-B format.

Another processing module is archive module 78, which is configured to perform the steps for storing each time tag measurement sample received to memory for future reference, and provide for the de-archive capability to other ADMS components. The utility module 80 provides utility functions to support ADMS components. This includes a library of utility functions called for use by other ADMS components, and stand-alone utility programs that are used by the ADMS operator. Finally, the analysis component 82 provides additional data capabilities beyond the core ADMS capabilities. These data capabilities include custom special-purpose programs, and interface programs for feeding data to the various work analysis packages.

Also in connection with telemetry processor 42 are a number of different databases. As with other components of the system, these databases may be combined in a single component or may be distributed across one or more networks in any number of ways. One database is the telemetry format 54, which stores information employable for decommutation of telemetry data. When telemetry is being generated, the contents of the data streams processed by the telemetry processor may be described in a multi-column text file, commonly called the format specification file. The format specification file may be configured as an IRIG-106 telemetry attribute transfer standard PCM data stream. The format specification file contains among other things: a measurement identification number, measurement description, engineering units (EU), polynomial coefficients for EU conversion, Bit rate, frame and word position information. As the ADMS receives its data directly from airborne and landline multiplexed PCM data streams, it performs its own decommutation of these serial data streams, and of the subcommutated data streams. The ADMS software reads the format file when software decommutation is initialized and then stores selected portions in “measurement buffers” in shared memory. The ADMS decommutates the PCM data, using specified telemetry format software files to identify the individual measurement samples.

The display format database 52 includes a number of display templates employable by the display portion of the system. The display portion of the system may employ such displays as the realtime strip chart, change of state, redline monitor, tabular displays, schematic displays, and or the ArcPlot display. These displays will be described in greater detail below. Included in this database may be any number of charts and graphs upon which real-time or archive data may be overlaid and transmitted to a GUI in connection with the system described herein.

The historical database 50 is configured to act as a repository for all of the decommutated data generated by the telemetry processor 42. This archive contains the value of each sample of each measurement in a telemetry stream accumulated over a period of time that the archive was being created. The ADMS saves every telemetry sample to the active archive volume in the telemetry processor. This active archive is divided into several reasonably sized partitions for manageability. Once an individual partition is filled, the data is available to be written to more permanent storage. Permanent storage media is typically a magneto-optical disk, a CDROM in a jukebox, or a directory on a hard disk array. Since there is no need for any of the above to be located together, this storage arrangement provides a psuedo online storage area network. The telemetry processor 42 communicates with a variety of workstations 56-66 through data network 49. The data network 49 may comprise any number of different types of networks such as LAN's, WAN's, and even the Internet.

Any number of workstations, such as workstations 56, 56, and 66, are connectable to the data network and may comprise computer systems running on any number of operating systems, such as the Sun Microsystems Solaris, Windows NT, etc. Configured on all or substantially all of the workstations may be a display processor 57 which includes a number of processing modules for presenting displays on the GUI of the workstation. Workstation 56, with the configuration of processing modules resident thereon, is exemplary of the workstations connectable to the data network. Other workstations connectable to the telemetry processor over the data network may have any number of configurations of the processing modules. Includable as part of the display processor 56 is ArcPlot module 84, which is a data review and analysis tool that provides the capability to employ either real-time or historical data from the archive, and to plot the data in a window presentable on a GUI. The ArcPlot module 84 further supports the display of data from different archives in the same window, and supports the production of “families of curves” which will be described in greater detailed below.

Also includable as modules on the workstation are the real time strip chart 59, the tabular display 60, redline monitor 62, change of state display 63, schematics 64, as well as the events database 65. The function of each of these modules will be described in greater detail below. Also connectable over the data network is archive data server 67 which is employable in conjunction with database 50 to provide local access to archived information. This server may be a standalone device or be resident on one or more of the workstations.

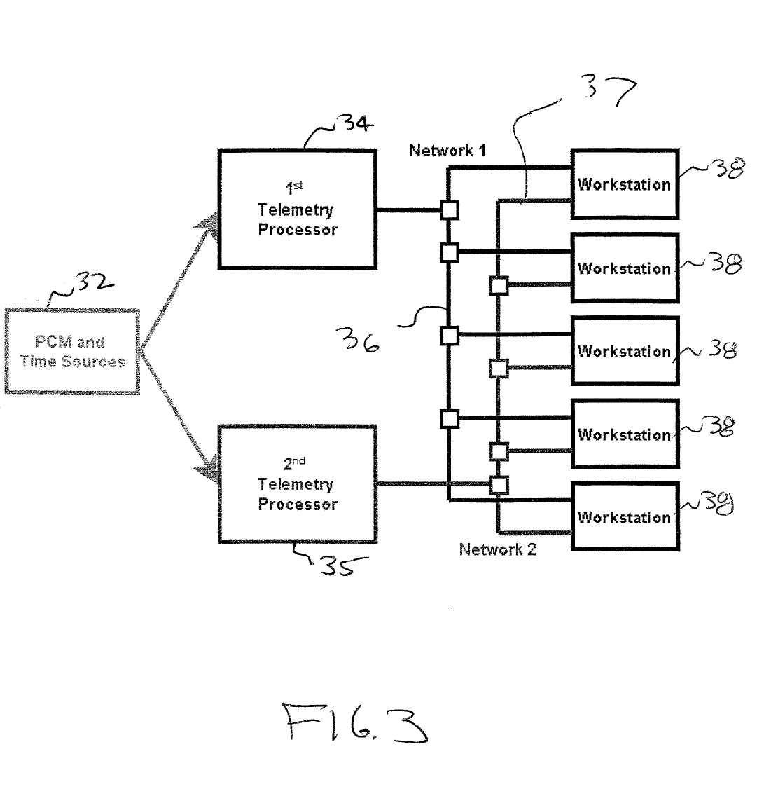

According to FIG. 3, the ADMS instances may be configured in a redundant manner such that two ADMS instances can process either two pads/vehicles simultaneously, or one pad/vehicle in a fully redundant configuration. The telemetry signals may be processed on at least first and second telemetry processors 34 and 35, respectively, which are configured as one or more network servers. The network servers may comprise Concurrent Powerhawks, or any number of commercially available networkable servers. The telemetry processor(s) process time and telemetry signals, and provides real-time and historical data to users at work stations.

In a redundant configuration, the telemetry and timing signals 32 are received by one or more telemetry process instances, 34 and 35. At the request of various ADMS installations accessible through the data network, the real-time and historical data may be presented on one or more workstations 38 in a desired manner.

As was described above, the workstations may run operating systems such as Solaris, Windows NT, etc. These configurations are satisfactory for both the redundant and non redundant systems. The display workstations 38 are configured such that they each host the graphical user interface (GUI). Networks 36 and 37 which pass information between the telemetry processors and the workstations may comprise local and wide area technologies. The software components necessary to perform various functions of the system may be distributed across the telemetry processor and display workstations as appropriate to accomplish a task such as decommutating and archiving data as well as broadcasting and receiving real-time data in addition to displaying and analyzing it on workstations.

The system described herein may be configured that even in a redundant configuration, each telemetry processor and workstation has the capability to serve ADMS archive data to other machines across the communications network. All currently mounted ADMS archive partitions are available to ADMS display programs, as long as the machine serving the archive data can be seen across the network by the display program, and the desired archive volume is listed in the ADMS archive database somewhere.

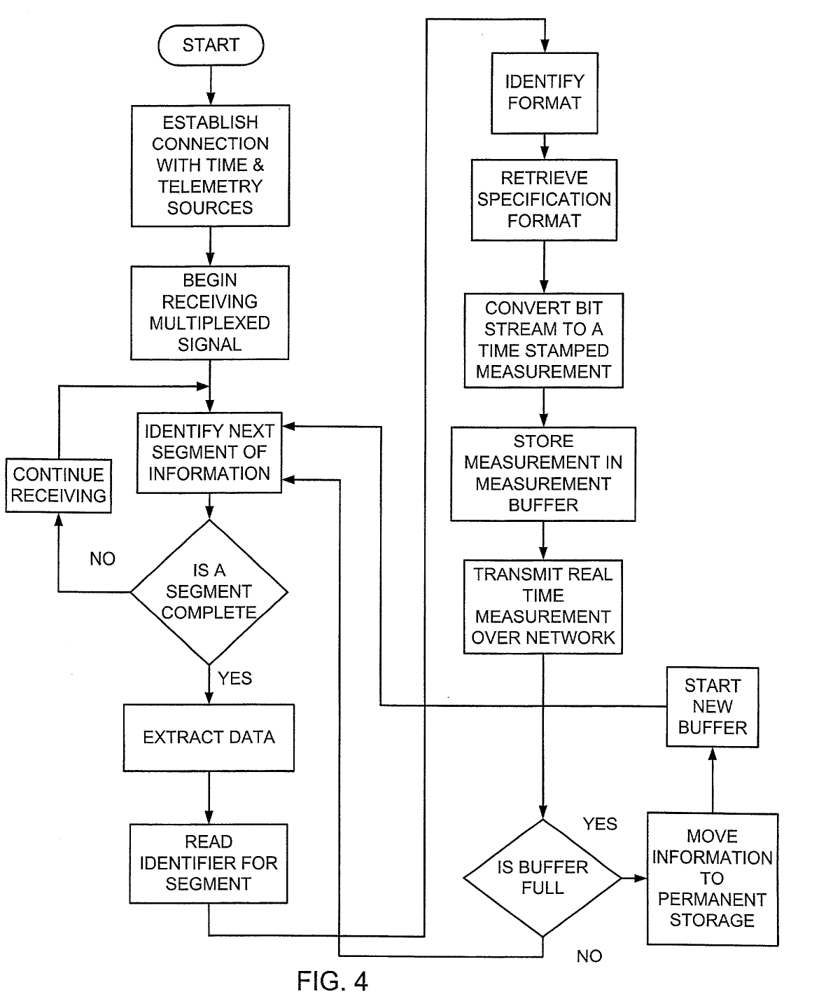

Described in FIG. 4 is a flow chart which details the steps performed by the telemetry processor in decommutating and storing telemetry data. As an initial step, the telemetry processor establishes a connection with the various telemetry and timing sources. As was described above, telemetry sources may include the ground station and launch vehicle, while the time signals may include things such as the IRIG-GMT source 44 and countdown source 46. The ADMS receives its data directly from airborne and landline multiplexed PCM data streams and performs its own decommutation of the serial data streams. As each segment in the data stream is identified, it includes one or more data identifiers which identify the particular type of data being extracted.

Data is extracted for each of the segments and an identifier is read to determine the type of information. Based on type of information (e.g., wind velocity, temperature, vehicle velocity, . . . ) the specification format database is accessed and a format specification filed for the particular type of measurement accessed in a matrix and retrieved. As was described above, this specification file may include such things as measurements identification number, measurement description, engineering units (EU), polynomial coefficient for EU conversion, the rate frame, and word position information.

As individual measurement samples are identified, the specification format files are employed during the decommutation and the values are stored in measurement buffers in a shared memory. The measurement buffers are part of an ADMS archive which contains the value of each sample of each measurement in the telemetry over the period of time the archive was being created. Once the processing of the particular measurement sample is complete, the next segment in the data stream is analyzed and the measurement sample converted and stored. This process continues until the telemetry signals are terminated.

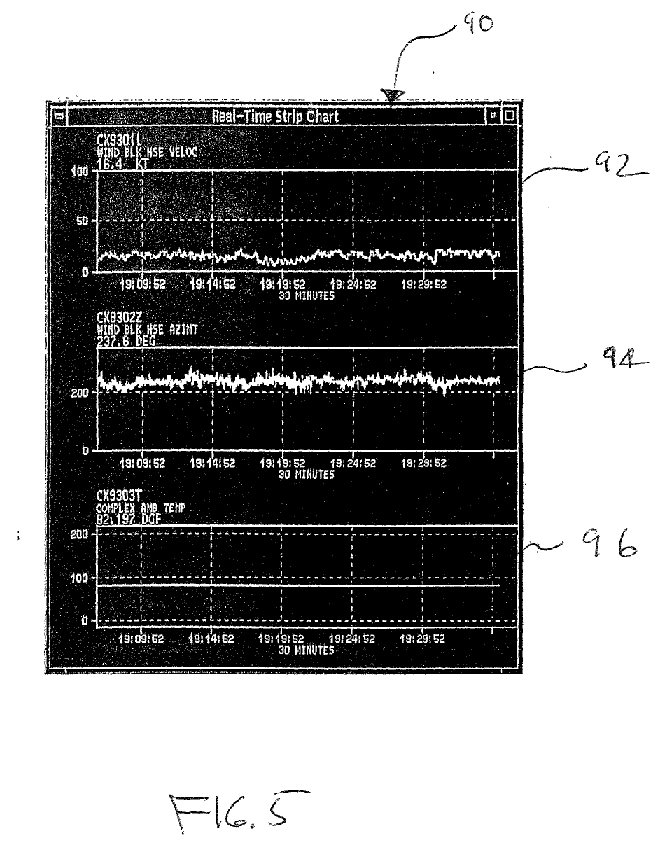

The processed telemetry data may be employed in the creation of one or more real-time displays. One example of such display is a real-time virtual strip chart, examples of which are disclosed in FIG. 5. These displays include user selected measurements as they are changing in real-time. The data is updated on the screen on a periodic basis but no information is lost, even for high sample rate measurements, due to the use of a high/low data display technique.

According to the high/low data display technique, between each update of a measurement on the real-time display, a number of measurement samples may be processed. For the display update period, both the high and low measurement samples are identified and then a graphical representation is created which spans the two values. The graphical representation may appear as a polygon which spans from the high to low values and at a particular point in time. In situations where a user wishes to view all the measurement samples during a period of time, these may be retrieved from the archive.

This system is configured such that a user can customize the format of the window, including window size, the number of virtual charts within the window, which measurements to display in each strip chart, measurement colors, and the vertical and time scales. Once a display is customized, it can be saved as a “view” and reloaded later, reducing the time spent in gaining access to the data.

In the example display 90 shown in FIG. 5, various strip charts 92 and 96 are employed to monitor various system characteristics. For example, strips 92 and 94 may be employed for monitoring wind velocity and direction, respectively, while display 96 is employable for monitoring ambient temperature at a location. Although, each measurement sample shown is measured against time, one skilled in the art would realize that other reference values may be employed as required by the particular measurement. Another feature incorporated in the system includes user selection any of the strip charts shown in FIG. 5 for individual viewing in a single window. The sample measurements may be further moved within a window and overlaid with one or more other measurements for waveform comparison.

The system described herein further includes the capability to monitor a vehicle under test while comparing the incoming real-time test data against earlier like tests for the same vehicle and/or against previously processed vehicles. The ADMS analysis programs are specialized data analysis programs that are not necessary for the operation of the core ADMS system. The analysis applications are specific tests that manipulate data and then correlate it to preset parameters.

The ArcPlot display provides review and analysis capability for a system user. ArcPlot provides capability to retrieve historic data from any ADMS archive and plot it in a window. ArcPlot supports the display of data from different archives in the same window, thereby supporting production of “families of curves”.

Employable in conjunction with ArcPlot tool is the events database which allows a user to quickly find a series of archive volumes which contain the same event for multiple vehicles, and generate a family of curves for those vehicles. While operating the system, an event database query may be presented through use of a dialog box. Through the dialog box a desired event criteria may be specified and a list of all known events which meet the criteria may then be searched and presented. A number of archive volumes are then presented in the dialog box. The user is then provided the option to select a record for reviewing. A pre-defined view may be entered, a measurement number entered, and/or a time duration and an offset selected. The system will retrieve data, and using the ArcPlot families of curves, display the data from the selected archive volumes. The events are defined by a set of rules which are processed by an expert system, such as a RT Works Experts System inference engine. The output in this process is a series of records which are written to a database.

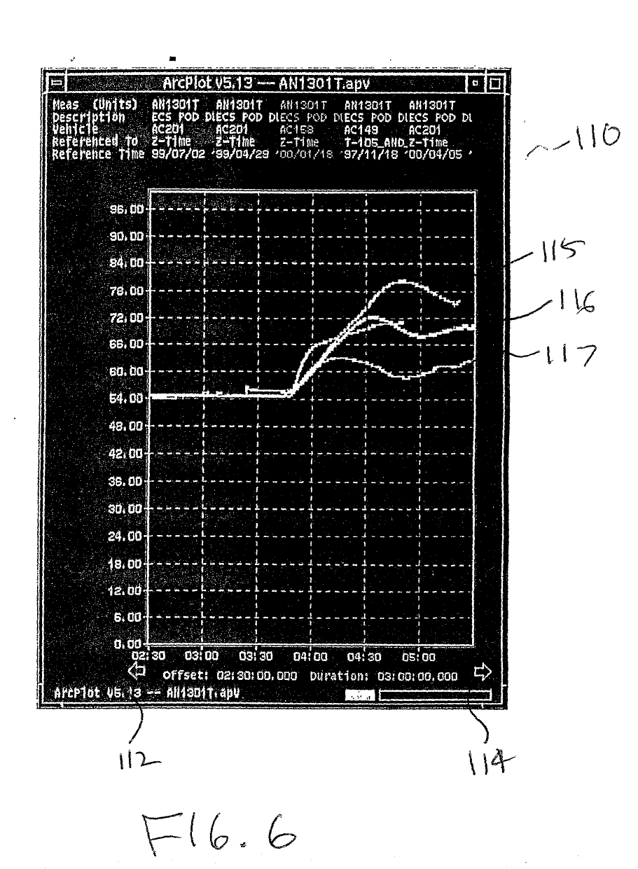

An example of the family of curves is shown in FIG. 6 with display 110. ArcPlot can be employed to generate a family of curves for virtually any measurement in the system in a matter of seconds. According to the system described herein, the user has the capability of scrolling through time by selection of either forwards and backwards arrows, 112 and 114 respectively.

Further, with regards to display 110 it is seen that a number of curves are presented thereon. According to the invention described herein, the functionality is provided to present multiple measurements where they include a combination of real-time and archive measurements plotted with respect to a reference time frame. As can be seen in FIG. 6, real-time measurement plot 115 is displayed, while, archive measurements are indicated by plots 116 and 117. Further, while viewing a display, various measurements may be added or removed. Adding a measurement integrates the action of selecting an archive volume, selecting the start time through dialog boxes, presentable on the GUI.

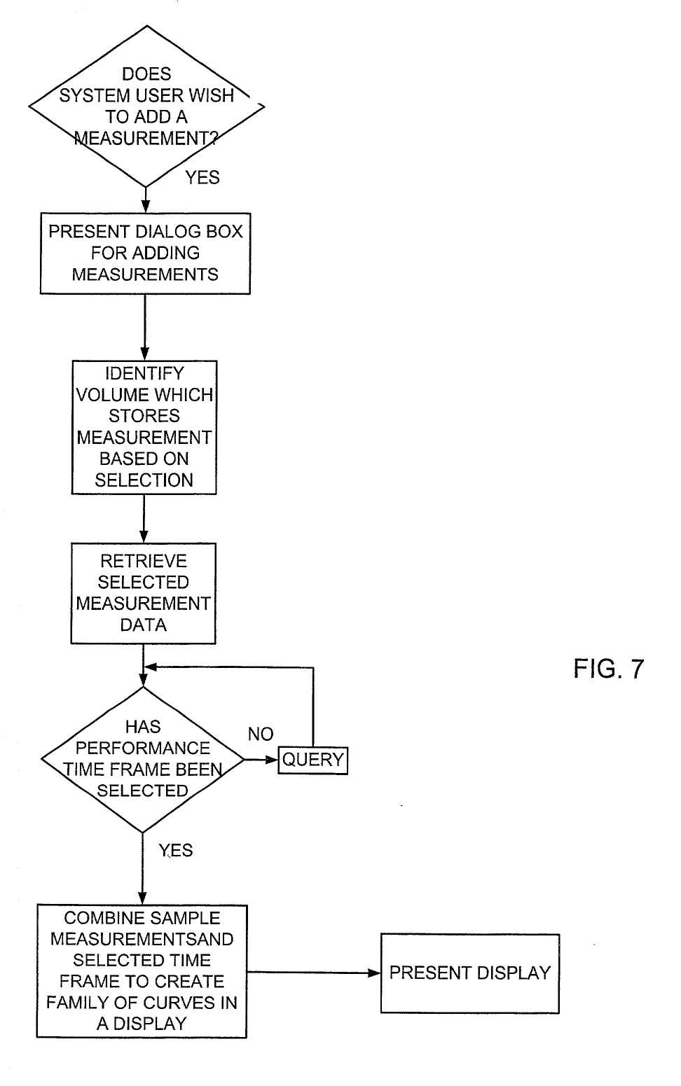

A flow chart describing the steps to add a measurement to a strip chart is disclosed in FIG. 7. The system continually monitors for various inputs by a user and when a user selects to add a measurement, a dialog box is presented which provides for selection of volumes and time frames. In order to provide for the presentation of the measurements, a reference time for the measurements must first be identified. This may be performed in three separate ways. If the actual time of the event is known, this may be entered in the dialog box and a time slider employed to set the time. The time slider is a display tool which when moved provides for a manual selection of a particular time. Another time selection may be made from a search performed of the desired countdown time. The countdown time may be entered in the dialog box and once again a time slider employed to select the desired point. The system may be configured to convert between such things as countdown time and other time frames employed during a particular monitoring. Finally, measurements may be referenced to a discrete event. Based on the event selected, measurements starting from a particular time are retrievable and displayed.

Once the reference time is set, the desired measurements from a volume in the archives are selected. A particular measurement may be identified by a measurement number, which is employed to retrieve the measurement sample. Through the steps described above, any number of measurements may be plotted and displayed on the GUI as a family of curves. User defined functions may also be added in substantially the same manner as described above. Once all items are selected, they are combined in a display and presented to a user.

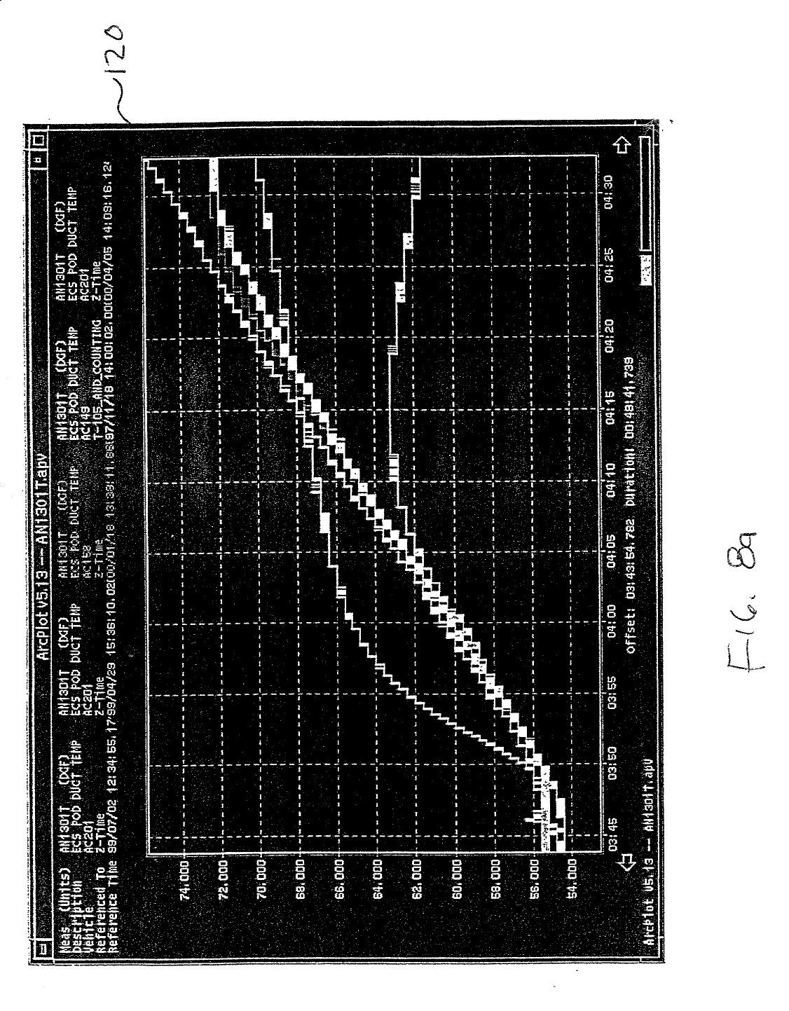

As was mentioned above, the ADMS archive is further configured to store every telemetered measurement sample, so ArcPlot also provides the ability to “zoom in” and provide better resolution for specific events of interest. Disclosed in FIG. 8a is a display 120 which includes a number of measurement samples over a significant period of time. In a situation where a system user wishes to analyze data generated during a smaller period of time, they may zoom in to the particular event. ArcPlot supports an intuitive two-click zoom-rectangle user interface to achieve this function. Zooming can continue to the point where each individual measurement sample is clearly visible. An example of such a plot 130 is provided in FIG. 8b wherein a number of individual samples 131 are clearly shown measured over seconds instead of minutes.

Another capability incorporated in the system is the ability to evaluate user-defined functions. This feature allows users to write functions, using a C-like language syntax, which operates on the value of one or more measurements of the system, and generates new values not previously available in any data stream. This functional capability is useful in manipulating obscure measurements such as thermocouples or strain gauges into real-world values, which are more meaningful. Another common function may be the filtering of noise data, so that the general trend of a measurement may be identified.

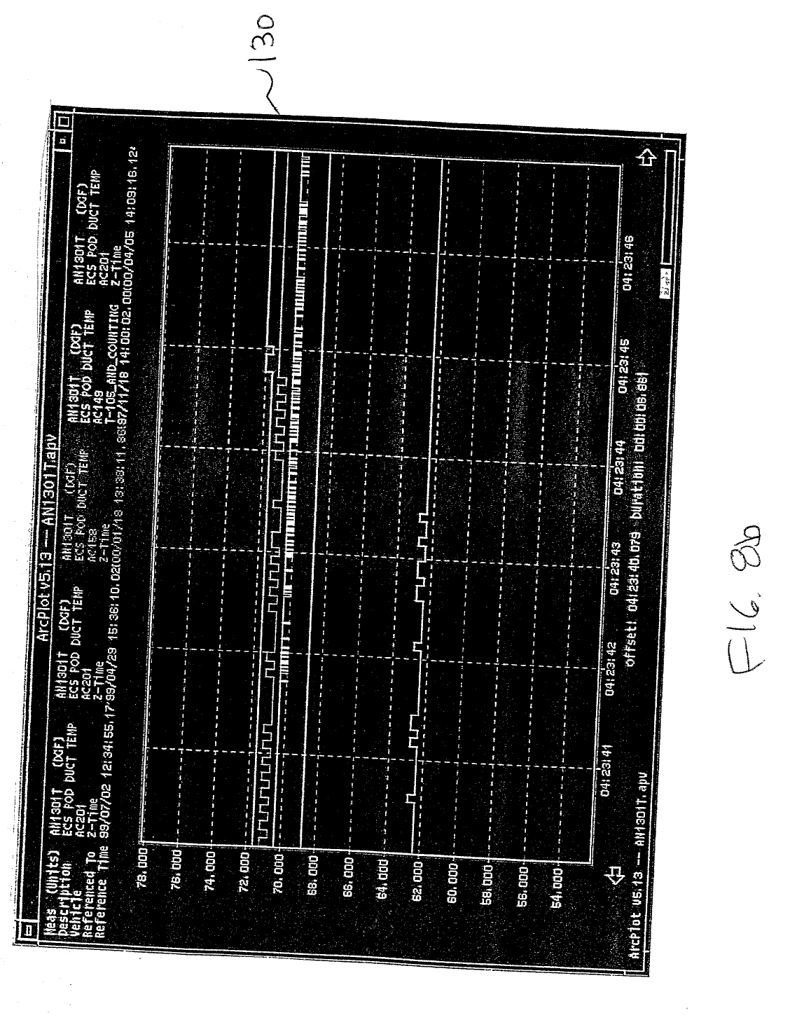

An example of such a user defined function is shown in display 140 of FIG. 9. Shown in particular are measurements of the wind speed where the individual measurements 142 have a large variance with a significant amount of noise incorporated therein. According to a user function employed herein, a rolling average of the wind velocity may be calculated and presented using plot 144. As can be seen, a wind velocity trend may be more clearly ascertained.

The system described herein may be further configured to generate a change-of-state display, which provides a listing of discrete (binary measurements) that have changed during the time period being viewed. Display programs may be available for viewing both real-time and archive change of state data. The display may show the measurement number, the new state, and the time the change of state occurred.

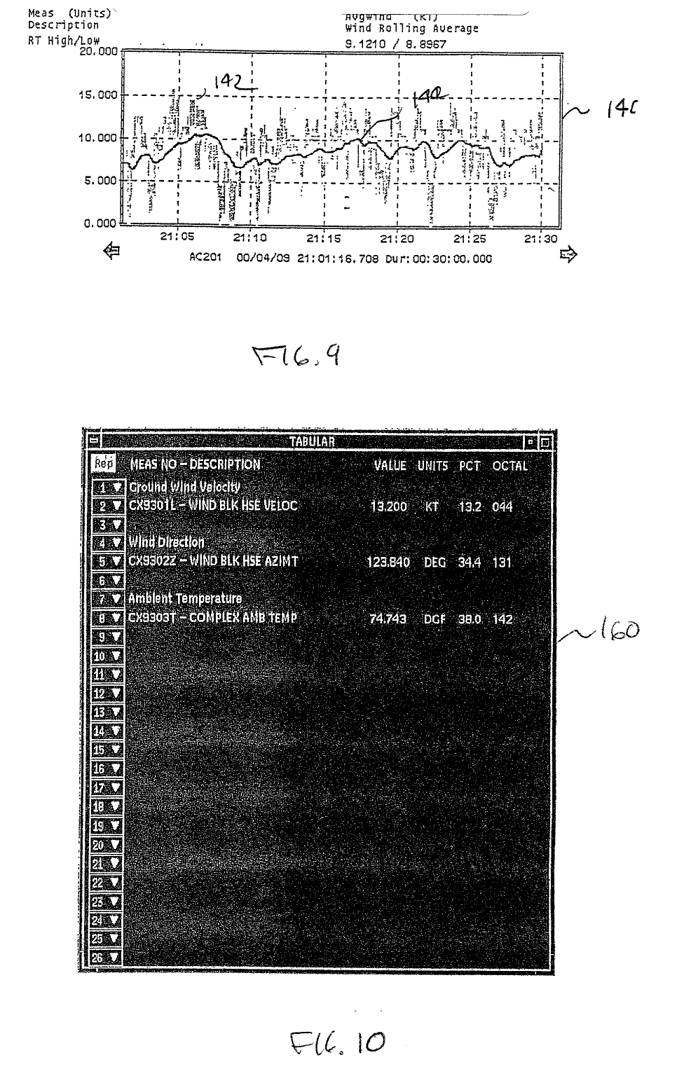

Other displays which may be generated at the workstations may include The ADMS tabular display. Disclosed in FIG. 10 is a sample ADMS tabular display 160 which show the current values of a list of user specified measurements in digital form. A particular number of measurements may be assigned to a specific view. Some of the formatting is user customizable, such as the units and raw data columns. The user can also assign upper and lower reference limits, so that when one or more measurement exceeds a user specified limit, the color of all text on the line containing the measurement changes to a specified color. As part of the real-time tabular display, measurement limits may provide the capability to automatically monitor any measurements for excursions outside of a user specified set of upper and lower limits.

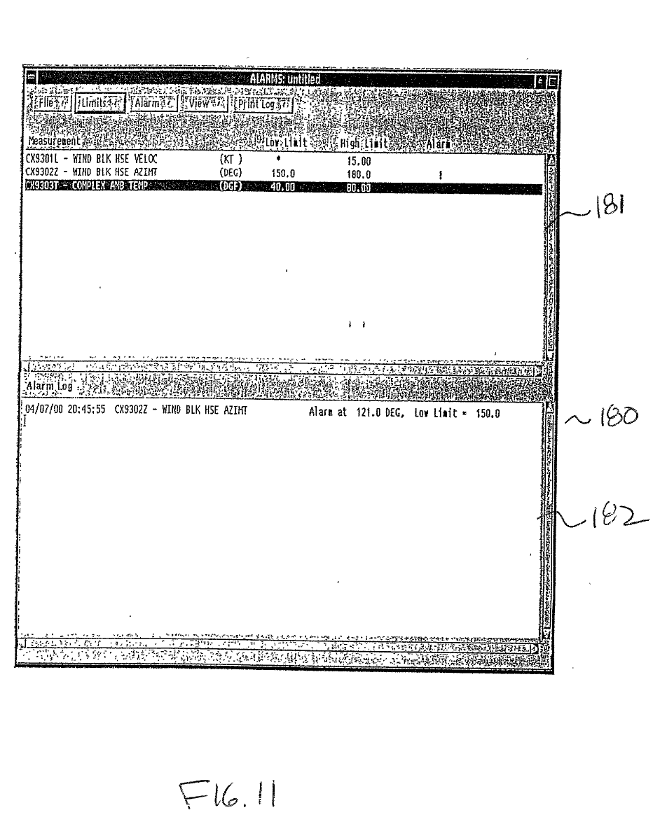

An example of an alarm monitor display 180 is disclosed in FIG. 11. Included in the particular display is dialog box 181 which includes a listing of user selectable measurement samples to be monitored. The system user may select from a list and add particular items through this portion. Once a measurement sample is selected, the system user may establish high or low limits beyond which the system user wishes to receive some sort of notification. This notification may be in the form of an audio warning or a visual change to the alarm monitor display 180. In order to track when certain limits are exceeded, an alarm log 182 may be included such that a system user can review the history of alarms.

Also employable may be a redline monitor display which presents a tabular view of all measurements that have operational and redline limits, whether or not they are currently in effect. A redline display may be similar to that shown in FIG. 10 where each measurement listed includes a redline limits. During operation, if any of the displayed measurement exceeds its configuration controlled limits, this tool may automatically invoke an ArcPlot display, such as a strip chart, to show the most recent history of the measurements. As part of the generation of the display, archived data relating to the particular measurement may be automatically retrieved and included on the plot so that comparisons may be made.

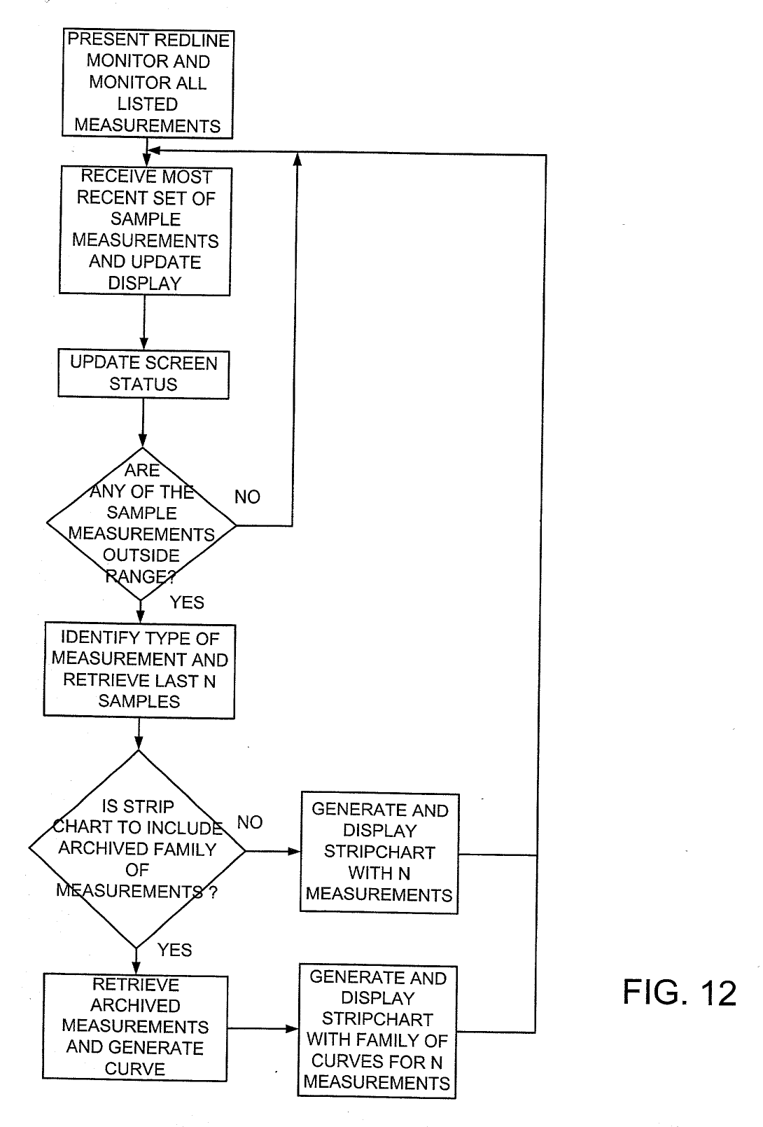

Disclosed in FIG. 12 is a flow chart which describes in detail the processes performed by the redline monitor portion of the system. As was noted above, either prior to operation or during operation, a user may alter the redefined lists of measurements to be included in the display, as well as limits to be evaluated. During the display of the tabular portion of the redline monitor, the telemetry processor continuously receives real-time measurement samples which are used to update the display. As these measurements are being processed, a determination is made as to whether the selected measurements are currently outside the range pre-established by the user and a value is entered in the redline monitor log. If the measurement is outside the range, a visual alarm is presented to the system user, which may be a redline strip chart which includes the particular measurement samples over a predetermined period of time, such as 5 minutes. Further, the system may be configured such that the redline monitor retrieves archived data for the particular measurement and includes this in a family of curves presentable on the strip chart for comparison purposes.

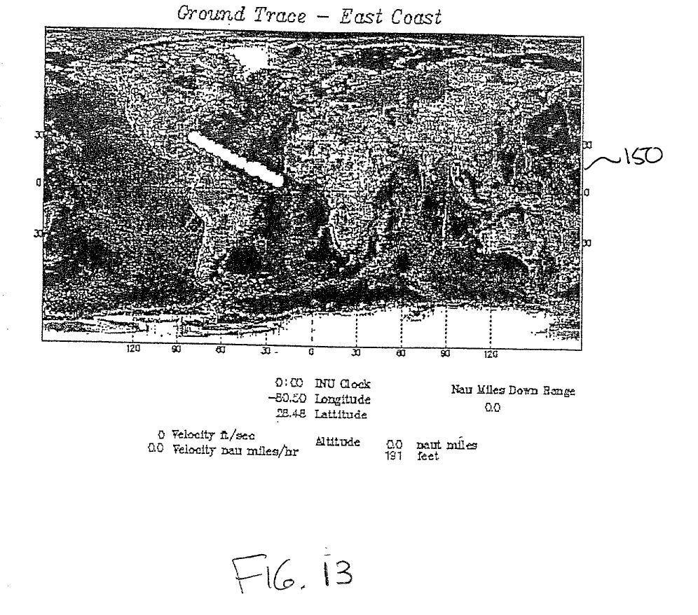

Yet another display employable in the system described herein is the real-time schematic display 150 disclosed in FIG. 13. The display supports graphical editing and dynamic display. In the sample display a graphical representation of an orbital track of a launch vehicle is imposed on a map. The animation of the orbital track is created based on the processing of telemetry data. This display provides the user with capability to draw a graphical diagram, then animate pieces of the diagram, based on the values of one or more measurements in the system. This display will also support the insertion of GIF-format pictures, which may be helpful in porting fixed graphics from other platforms. These displays are useful for showing real-time vehicle data in a simplified graphical schematic form.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A telemetry processing and presentation system comprising:
a telemetry processor configured to receive telemetry signals from a plurality of telemetry sources, said processor being further configured to decommutate data streams included as part of the telemetry signals into individual measurement samples;
a first memory configured to store telemetry formats employable by the telemetry processor to identify the individual measurements samples and associate the samples with descriptive information;
a second memory to store display formats which are accessible by the telemetry processor for presenting telemetry information in at least one format for presentation on a graphical user interface; and
said processor is further connected to data network and is configured to transmit the formatted telemetry data over a data network to at least one of the graphical user interfaces which are connectable to the data network for selective display.

2. The system of claim 1 further including a 3^{rd} memory configured to archive the individual measurement samples for future use.

3. The system of claim 2 wherein the processor is further configured to retrieve a selection of archived measurement samples from the 3^{rd} memory and to further process the retrieved measurement samples from the archive for presentation on a graphical user interface.

4. The system of claim 3 wherein the processor is further configured to simultaneously present the selected archived measurement samples and the formatted telemetry data on a single display format for presentation on the graphical user interface.

5. The system of claim 2 wherein the formatted telemetry is configured in a strip chart format.

6. The system of claim 5 wherein the formatted telemetry includes a selected measurement over a predetermined time period.

7. The system of claim 6 wherein the strip chart is configurable to include the formatted telemetry and selected of the archived measurement samples presented relative to a selected event.

8. The system of claim 5 wherein the formatted telemetry is presentable such that a system user may selectably alter resolution when viewing on the at least one GUI.

9. The system of claim 1 wherein the telemetry sources include at least one of: range formatted countdown clock signal, landline PCM data stream, airborne PCM data stream, other PCM or internally-generated data streams.

10. The system of clam 1 wherein the telemetry formats for each item include at least one of: a measurement identification number, measurement description, engineering units, polynomial coefficients for EU conversion, and bit rate, frame and word position information.

11. The system of claim 5 wherein the processor is further configured to filter the measurement samples and present the formatted telemetry in a manner which identifies trends in the measurement samples.

12. The system of claim 1 wherein the formatted telemetry is further presentable in a tabular display format which displays a selection of the individual measurement samples in tabular form which are updated on a periodic basis.

13. The system of claim 1 wherein the processor is further configured to monitor selected of the measurement samples and include at least one of: a visual and audio alert, when at least one of the selected measurement samples is outside a predetermined range of values.

14. The system of claim 13 wherein the processor is further configured to present a redline display upon detection of a selected condition, wherein the redline monitor includes a plurality of a values for a selected one of the measurement samples graphed over a predetermined period of time.

15. The system of claim 1 further including a plurality of the telemetry processors connected in a redundant manner, wherein the plurality of telemetry processors are further configured to monitor a plurality of locations.

16. The system of claim 7 further including an events database configured to time reference information relating the selected event.

17. A method for processing and preparing for display telemetry data comprising the steps of:
receiving a plurality of telemetry and timing signals from a plurality of telemetry sources;
decommutating serial data streams in the telemetry signals and employing one or more telemetry formats retrieved from memory to identify individual measurement samples;
incorporating the measurement samples in one or more display formats retrieved from memory; and
transmitting the display formats with the measurement samples incorporated therein over a data network for display on at least one remotely located graphical user interface (GUI) connected with the data network.

18. The method of claim 17 further comprising the step of archiving each of the measurement samples in memory.

19. The method of claim 18 further comprising the step of combining one or more of the archived measurement samples with one or more of the measurement samples in a display format and transmitting the combined display format over the data network for viewing on the at least one remotely located GUI.

20. The method of claim 19 wherein the display format is a strip chart in which the measurement samples are plotted against time and the display format is periodically updated to include the measurement samples which were most recently decommutated and processed.

21. The method of claim 17 wherein the telemetry sources include at least one of: at least one launch vehicle and at least one ground station monitoring the at least one launch vehicle.

22. The method of claim 21 wherein the telemetry sources include at least one of: range formatted countdown clock signal, landline PCM data stream, airborne PCM data stream, other PCM or internally-generated data streams.

23. The method of claim 21 further comprising the step of filtering the measurement samples and presenting on the display format so as to identify data trends.

24. The method of claim 17 further comprising the step of modifying the display format to present a desired resolution of the measurement samples based on a detected user input.

25. The method of clam 17 wherein the telemetry formats for each item include at least one of: a measurement identification number, measurement description, engineering units, polynomial coefficients for EU conversion, and bit rate, frame and word position information.

26. The method of claim 20 further comprising the step of retrieving a specified time frame based on a selected event wherein the strip chart includes both a the measurement samples and selected of the archived measurement samples plotted with regards to the selected event.

27. The method of claim 17 wherein the display format comprises the measurements samples presented in a tabular display.

28. The method of claim 17 further comprising the step of monitoring the measurement samples and generating at least one of: an audio alert and a visual alert which is presentable on the at least one GUI when the measurement samples are outside a first predetermined range.

29. The method of claim 28 further comprising the step of generating and presenting a redline display when the measurement samples are detected outside a second predetermined range.

30. The method of claim 17 further comprising the step of simultaneously monitoring a plurality of sources of the telemetry data and providing display formats for measurement samples from each of the sources.

31. The method of claim 18 wherein further comprising the step of configuring the display format to simultaneously present a plurality of different types of the measurement samples.
